(19) United States
(12) Patent Application Publication
(10) Pub. No.: US 2025/0081053 A1
(43) Pub. Date: Mar. 6, 2025

(54) System and Method for Roaming Between Base Stations

(71) Applicant: ZEBRA TECHNOLOGIES CORPORATION, Lincolnshire, IL (US)

(72) Inventors: Ambarish Almelkar, Bangalore (IN); Vachan Banavara Ramesh, Bangalore (IN); Hanamant Hullur, Karnataka (IN); Venkata Aneel Kumar Inuganti, Bangalore (IN)

(21) Appl. No.: 18/240,211

(22) Filed: Aug. 30, 2023

(51) Int. Cl. H04W 36/00; H04W 36/02; H04W 36/08; H04W 48/16

(52) U.S. Cl. CPC H04W 36/00835; H04W 36/023; H04W 36/08; H04W 48/16

(57) ABSTRACT

An example mobile computing device includes: a wireless communications interface configured to connect to a network deployed by a plurality of base stations; a controller for the wireless communications interface, the controller configured to: initiate a scan for foreign base stations; when the scan is complete, return to a home base station and initiate a home channel dwell time; receive a data packet from the home base station during the home channel dwell time; receive an indicator that transmission of buffered data packets from home base station is complete; and in response to the indicator, terminate the home channel dwell time.

### BACKGROUND

Wireless networks may be serviced by several access points to which mobile devices can connect based on their location within the wireless network. As users of mobile devices move around, the mobile devices may roam to different access points. To identify a suitable access points to roam to, the mobile devices may perform scans, however scans take time which may result in the mobile device being serviced by an access point with poor quality of service.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for roaming between access points.

FIG. 2 is a block diagram of certain internal hardware components of the mobile device of FIG. 1.

FIG. 3 is a flowchart of a method roaming between access points.

FIG. 4 is a schematic diagram of an example scan iteration, default roaming operation and shortened roaming operation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a mobile computing device comprising: a wireless communications interface configured to connect to a network deployed by a plurality of base stations: a controller for the wireless communications interface, the controller configured to: initiate a scan for foreign base stations: when the scan is complete, return to a home base station and initiate a home channel dwell time; receive a data packet from the home base station during the home channel dwell time; receive an indicator that transmission of buffered data packets from home base station is complete; and in response to the indicator, terminate the home channel dwell time.

Additional examples disclosed herein are directed to a method comprising: initiating a scan for foreign base stations: when the scan is complete, returning to a home base station and initiating a home channel dwell time: receiving a data packet from the home base station during the home channel dwell time: receiving an indicator that transmission of buffered data packets from home base station is complete; and in response to the indicator, terminating the home channel dwell time.

Additional examples disclosed herein are directed to a non-transitory machine-readable medium storing instructions which when executed, configure a controller of device to: initiate a scan for foreign base stations: when the scan is complete, return to a home base station and initiate a home channel dwell time: receive a data packet from the home base station during the home channel dwell time: receive an indicator that transmission of buffered data packets from home base station is complete; and in response to the indicator, terminate the home channel dwell time.

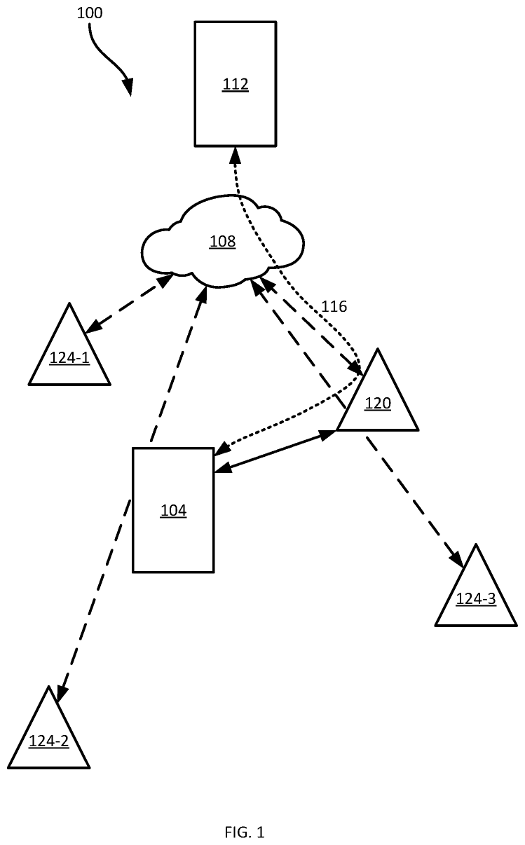

FIG. 1 depicts a system 100 for roaming between access points with reduced scan times in accordance with the teachings of this disclosure. The system 100 includes a computing device 104 (also referred to herein as simply the device 104) connected to a network 108. The device 104 may communicate with a second computing device 112 (also referred to herein as the peer device 112) via a link 116 which traverses the network 108. In some examples, the device 112 may be remote from the device 104 and the link 116 may therefore additionally traverse one or more wide-area networks such as the Internet, mobile networks and the like.

The device 104 may be a mobile computing device such as a handheld computer, a mobile phone, a tablet, a barcode scanner or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) and/or a wireless wide area network (WWAN) deployed by one or more base stations, including without limitation one or more access points and/or cellular base stations, citizens broadband radio service (CBRS) base stations, or the like. In the present example, four access points, a home access point 120, and three foreign access points 124-1, 124-2, and 124-3 are depicted. In other examples, the network 108 may include more or fewer access points.

In particular, the device 104 may be currently serviced by the home access point 120 to connect to the network 108. The device 104 may occasionally pause its connection to the home access point 120 including wireless transmissions to and from the home access point 120 for a variety of reasons.

For example, since the device 104 may be mobile, the device 104 may be carried about by a user. As the user of the device 104 moves about the facility or other region serviced by the network 108, the connection of the device 104 to the home access point 120 may weaken, and the device 104 may be better serviced by another foreign access point 124 of the network 108. Accordingly, the device 104 may scan the foreign access points 124 and may subsequently roam to one of the foreign access points 124 to connect to the network 108, for example when the device 104 is out of range of the home access point 120 and/or when a better connection may be achieved via one of the foreign access points 124.

To roam to a foreign access point 124 from the home access point 120, the device 104 may periodically scan for foreign access points 124 to which the device 104 may connect. While the device 104 scans for foreign access points 124, the device 104 may temporarily disconnect from the home access point 120, and hence any communications and data transmissions to and from the device 104 may be temporarily disrupted. Accordingly, to maintain data transmissions, the home access point 120 may buffer data packets to be sent to the device 104. Upon completion of the scan, the device 104 returns to the home access point 120 for an amount of time, known as a home channel dwell time. The home channel dwell time may have a predefined default duration. During the home channel dwell time, the device 104 receives the buffered data packets and any new incoming data packets received.

To balance time spent away from the home access point 120 and identification of a suitable foreign access point 124 to roam to, the device 104 may perform multiple scans. For example, a selection process to select a foreign access point 124 may include a predefined number of scans and a corresponding number of home channel dwell times at the home access point 120 after each scan. After the predefined number of iterations of scans and dwell times, the device 104 may select a new access point from the foreign access points 124 identified in the scans and may roam to the selected access point.

The predefined default duration of the home channel dwell time may be selected to be sufficiently long to transmit the data packets buffered at the home access point 120 over the duration of the scan (e.g., 120 ms). If fewer data packets are buffered than the number of data packets transmissible during the dwell time, then at least a portion of the dwell time may be down time in which no exchange of data packets is occurring. The dwell time may therefore extend the duration of the overall roaming process (i.e., including the selection process of scanning and returning to the home access point for the dwell time in order to make a selection of a new access point and the roaming operation to the selected new access point). The time for the full roaming process may result in lower quality of communications, as the connection of the device 104 to the home access point 120 may deteriorate over the duration of the full roaming process.

Thus, in accordance with the teachings of the present disclosure, the device 104 may receive an indicator from the home access point 120 that transmission of the buffered data packets from the home access point is complete. That is, the indicator may indicate that no further data packets are buffered at the home access point 120. In response to the indicator, the device 104 may terminate the home channel dwell time, irrespective of completion of the predefined default duration of the home channel dwell time. The device 104 may therefore terminate the home channel dwell time prior to expiry of the default duration to avoid down time in which no data packets are exchanged, and may proceed instead to the subsequent scan for foreign access points. The time for each scan/dwell time iteration may therefore be shortened, resulting in a faster selection process and overall roaming process.

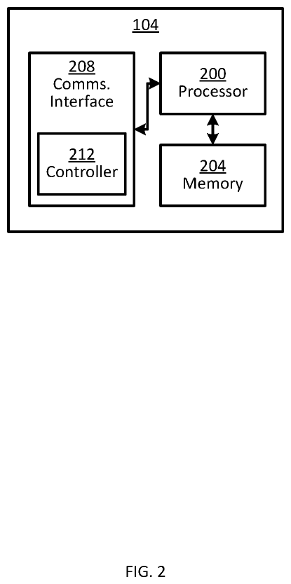

Turning now to FIG. 2, certain internal components of the computing devices 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the device 112. The communications interface 208 is interconnected with the processor 200. The communications interface 208 includes a controller 212, and one or more antennas, transmitters, receivers, or the like (not shown), to allow the device 104 to communicate with other computing devices such as the device 112 via the link 116.

The controller 212 may be a micro-controller, a micro-processor, or other suitable device capable of executing computer-readable instructions to control the components, such as the antennae, transmitters, receivers, and the like, of the communications interface 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control an operation to negotiate a priority order of performing pause operations to desynchronize the pause operations.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

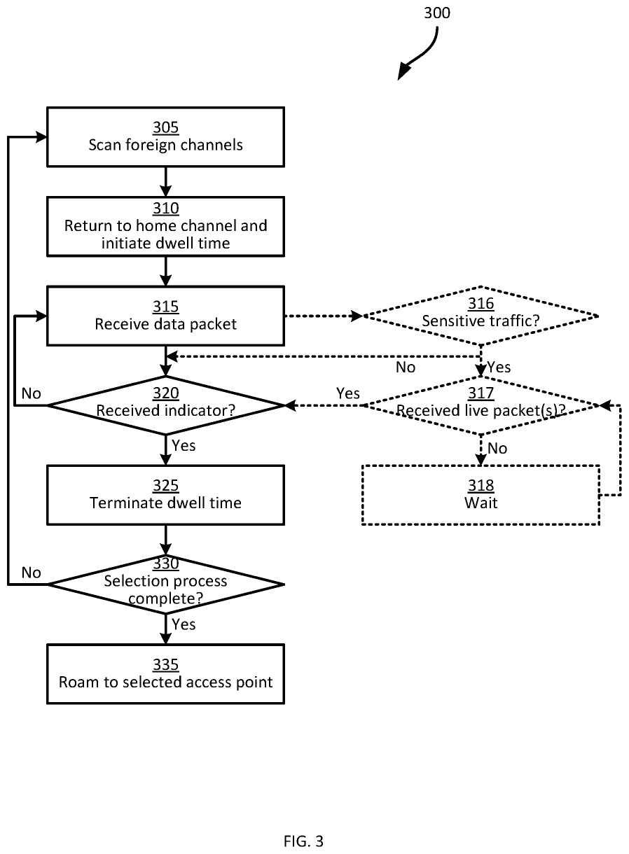

FIG. 3 illustrates a method 300 of negotiating a priority order to desynchronize pause operations. The method 300 will be discussed in conjunction with its performance in the system 100, and particularly by the device 104. In particular, the method 300 will be described with reference to the components of FIGS. 1 and 2. In other examples, the method 300 may be performed by other suitable devices and/or in other suitable systems.

The method 300 is initiated at block 305, where the device 104 initiates a scan for foreign access points 124. The scan may be initiated, for example, in response to detecting that a signal strength to the home access point 120 is below a threshold strength, that a quality of service (e.g., as determined based on jitter, latency, etc.) is below a predetermined threshold, or other similar condition. The scan may have a predefined scan duration, during which the device 104 may identify one or more candidate foreign access points 124, as well as corresponding connection parameters, signal strength, and the like. In particular, the device 104 may pause the connection to the home access point 120 and move off-channel to perform the scan.

At block 310, after completion of the scan at block 305, for example via expiry of the predefined scan duration, the device 104 returns to the home channel and initiates a home channel dwell time. For example, the device 104 may initiate a timer at the time of reconnection to the home access point 120.

At block 315, the device 104 may receive a data packet from the home access point 120. The data packet may be a buffered data packet which was buffered at the home access point 120 while the device 104 was off-channel performing the scan at block 3045, or the data packet may be a new data packet received during the home channel dwell time.

In some examples, after receiving a data packet at block 315, the device 104 may proceed directly to block 320, while in other examples, the device 104 may be configured to proceed based on the type of data packet received.

In particular, optionally at block 316, the device 104 may determine whether the data packet received at block 315 is for a predefined type of traffic, such as time-sensitive traffic, such as a voice or video packet for a real-time streaming-based application. In particular, for sensitive traffic, packet loss may be reduced by ensuring receipt of two or more live data packets.

If the determination at block 316 is negative, that is, the traffic being transmitted is best-effort or non-sensitive traffic, then the device 104 may proceed to block 320.

If the determination at block 316 is affirmative, then the device 104 may proceed to block 317. At block 317, the device 104 determines whether a threshold number of live (i.e., not buffered) data packets have been received for the sensitive traffic. The threshold number may be two to three live data packets, for example, and may be selected to minimize packet loss during the exchange of the sensitive data packets.

If, at block 317, the threshold number of data packets have not yet been received, then the device 104 proceeds to block 318 to continue to wait for live packets. The device 104 may continue to iterate through blocks 317 and 318 until the threshold number of data packets are received, or until the home channel dwell time expires. That is, the device 104 may wait for a threshold number of data packets prior to terminating the home channel dwell time.

If, at block 317, the threshold number of data packets have been received, then the device 104 proceeds to block 320.

At block 320, the device 104 determines whether an indicator was received, the indicator indicating that transmission of buffered data packets from the home access point is complete. For example, the indicator may be a bit in the data packet received at block 315 (e.g., a bit in the header of the data packet, or similar) configured to indicate whether further data packets are buffered at the home access point 120. In particular, the bit may be set to indicate completion of buffered data packets for each buffered or new data packet transmitted from the home access point 120. In other examples, the indicator may be transmitted in a dedicated data packet from the home access point 120, via a beacon from the home access point, or another suitable means.

If the determination at block 320 is negative, that is, the indicator indicates that further buffered data packets are buffered at the home access point 120, then the device 104 returns to block 315 to receive a subsequent data packet. The device 104 may continue to iterate through blocks 315 through 320 until the device 104 receives an indicator, resulting in an affirmative determination at block 320, or until the home channel dwell time expires.

If the determination at block 320 is affirmative, that is, the device 104 receives an indicator indicating that transmission of buffered data packets is complete, then the device 104 proceeds to block 325. At block 325, the device 104 actively terminates the home channel dwell time. In particular, the active termination at block 325 may occur irrespective of the remaining dwell time, and hence the device 104 may terminate the home channel dwell time prior to expiry of the predefined default duration.

In particular, to terminate the home channel dwell time, the device 104 may proceed to a subsequent action after completion of the dwell time, such as a subsequent scan or a roam operation to a selected access point. The manner of termination of the home channel dwell time may depend on the progress of the device 104 in the selection process for identifying a new access point to roam to. Accordingly, at block 330, the device 104 may determine whether the selection process is complete. The device 104 may determine that the selection process is complete, for example, after a predefined number of iterations of scanning and returning to the home access point 120 for a dwell time. In other examples, the device 104 may determine that the selection process is complete if a foreign access point 124 has been identified which meets certain predefined criteria, such as a threshold signal strength or quality of service. In such examples, the device 104 may determine that the selection process is complete prior to completion of the predefined number of iterations of scans.

In some examples, the determination at block 330 of completion of the selection process may additionally or alternatively be completed upon return to the home access point 120 in order to initiate a home channel dwell time of a suitable length based on completion of the selection process.

If the determination at block 330 is negative, the device 104 may terminate the home channel dwell time by returning to block 305 to initiate a subsequent scan for further foreign access points.

If the determination at block 330 is affirmative, the device 104 may terminate the home channel dwell time by proceeding to block 335 to switch from the home access point 120 to a selected target access point, as identified from the selection process. For example, the device 104 may switch from the home access point 120 to the foreign access point 124-1.

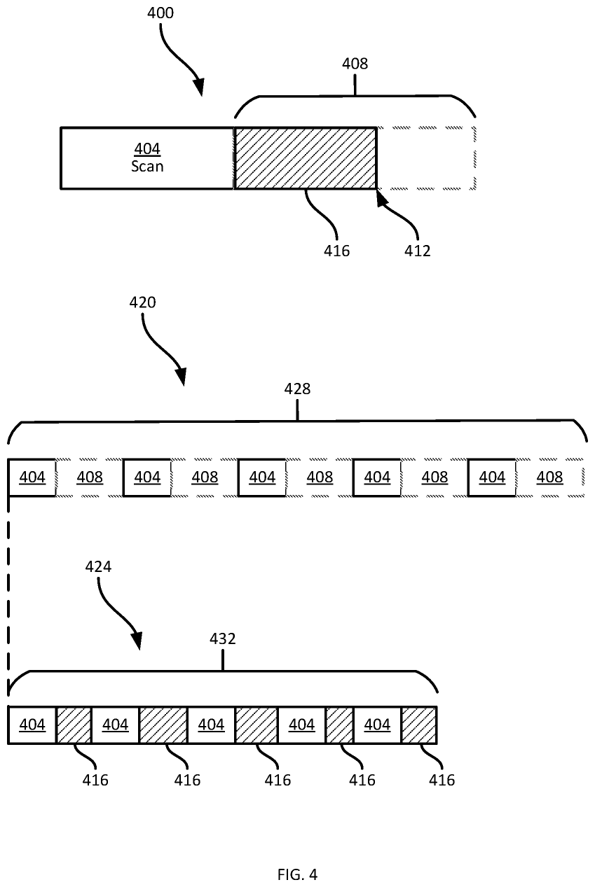

Thus, in accordance with the present disclosure, each scan and home channel dwell time iteration may be reduced, resulting in a reduced time overall for scanning, selecting a new access point, and roaming to the selected access point. For example, referring to FIG. 4, an example iteration 400 is depicted, including a scan 404 having a predefined scan time and a home channel dwell time with a default duration 408. In accordance with the present disclosure, during the home channel dwell time, the device 104 may receive an indicator that transmission of buffered data packets from the home access point is complete (i.e., that no further data packets are buffered at the home access point) and terminate the home channel dwell time at 412, resulting in a shortened home channel dwell time 416.

FIG. 4 further depicts a default roaming operation 420 and a shortened roaming operation 424, each including five iterations 400 of scanning and returning to the home access point for a dwell time. With the default duration 408 of each home channel dwell time, the roaming operation 420 has an aggregate duration 428. With the shortened home channel dwell time 416, the roaming operation 424 has an aggregate duration 432 which is reduced from the aggregate duration 428. Accordingly, the overall roaming operation, including scanning, selecting a new access point and roaming to the selected access point with the shortened home channel dwell time may be faster and reduce the amount of time the device 104 remains at the home access point 120 with a quality of service or signal strength below the threshold level.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile computing device comprising:
a wireless communications interface configured to connect to a network deployed by a plurality of base stations;
a controller for the wireless communications interface, the controller configured to:
initiate a scan for foreign base stations;
when the scan is complete, return to a home base station and initiate a home channel dwell time;
receive a data packet from the home base station during the home channel dwell time;
receive an indicator that transmission of buffered data packets from home base station is complete; and
in response to the indicator, terminate the home channel dwell time.

2. The mobile computing device of claim 1, wherein, to terminate the home channel dwell time, the controller is configured to initiate a subsequent scan for foreign base stations.

3. The mobile computing device of claim 1, wherein, to terminate the home channel dwell time, the controller is configured to switch from the home base station to a selected target base station.

4. The mobile computing device of claim 1, wherein the indicator comprises a bit in the data packet received from the home base station.

5. The mobile computing device of claim 1, wherein, when the data packet comprises a predefined traffic type, the controller is configured to wait for a threshold number of further data packets prior to terminating the home channel dwell time.

6. A method comprising:
initiating a scan for foreign base stations;
when the scan is complete, returning to a home base station and initiating a home channel dwell time;
receiving a data packet from the home base station during the home channel dwell time;
receiving an indicator that transmission of buffered data packets from home base station is complete; and
in response to the indicator, terminating the home channel dwell time.

7. The method of claim 6, wherein terminating the home channel dwell time comprises initiating a subsequent scan for foreign base stations.

8. The method of claim 6, wherein terminating the home channel dwell time comprises switching from the home base station to a selected target base station.

9. The method of claim 6, wherein the indicator comprises a bit in the data packet received from the home access point.

10. The method of claim 6, further comprising, when the data packet comprises a predefined traffic type, waiting for a threshold number of further data packets prior to terminating the home channel dwell time.

11. A non-transitory machine-readable medium storing instructions which when executed, configure a controller of device to:
initiate a scan for foreign base stations;
when the scan is complete, return to a home base station and initiate a home channel dwell time;
receive a data packet from the home base station during the home channel dwell time;
receive an indicator that transmission of buffered data packets from home base station is complete; and
in response to the indicator, terminate the home channel dwell time.

12. The non-transitory machine-readable medium of claim 11, wherein, to terminate the home channel dwell time, the controller is configured to initiate a subsequent scan for foreign base stations.

13. The non-transitory machine-readable medium of claim 11, wherein, to terminate the home channel dwell time, the controller is configured to switch from the home base station to a selected target base station.

14. The non-transitory machine-readable medium of claim 11, wherein the indicator comprises a bit in the data packet received from the home base station.

15. The non-transitory machine-readable medium of claim 11, wherein, when the data packet comprises a predefined traffic type, the controller is configured to wait for a threshold number of further data packets prior to terminating the home channel dwell time.
